(19) United States
(12) Patent Application Publication
(10) Pub. No.: US 2025/0038233 A1
(43) Pub. Date: Jan. 30, 2025

(54) INSULATING PROTECTIVE MECHANISM, CONVEYING APPARATUS, AND FLOW BATTERY ENERGY STORAGE SYSTEM

(71) Applicant: VRB Energy Inc., Grand Cayman (KY)

(72) Inventors: Yulong Shi, Beijing (CN); Zhiwei Duan, Beijing (CN); Hedi Ma, Beijing (CN); Shuai Dong, Beijing (CN); Yongkai Han, Beijing (CN); Dehao Wang, Beijing (CN); Huichao Liu, Beijing (CN); Qiming Ge, Beijing (CN)

(21) Appl. No.: 18/742,684

(22) Filed: Jun. 13, 2024

(30) Foreign Application Priority Data
Jul. 24, 2023 (CN) 202321957583.8

(51) Int. Cl. H01M 8/04276; H01M 8/18

(52) U.S. Cl. CPC H01M 8/04276; H01M 8/188

(57) ABSTRACT

Embodiments of the present disclosure disclose an insulating protective mechanism, a conveying apparatus, and a flow battery energy storage system, which relate to, but are not limited to, insulating protection technology. The insulating protective mechanism comprises a frame, an insulating protective cover, a transmission assembly, a sensing assembly, and a control unit. The insulating protective cover is arranged on the frame, and can enclose with the frame an installation space for installing a conveying mechanism. The control unit controls the transmission assembly to facilitate driving the insulating protective cover to open or close the installation space, so as to facilitate maintenance and replacement of the conveying mechanism in the installation space, and reset the insulating protective cover after the maintenance and replacement of the conveying mechanism. The sensing assembly can monitor whether the installation space is closed, to prevent the conveying apparatus and the flow battery energy storage system from being turned on when the insulating protective cover is not closed, thereby reducing a risk of electric shock.

### RELATED APPLICATIONS

This application claims priority to Chinese Patent Application No. 202321957583.8, filed Jul. 24, 2023, and titled INSULATING PROTECTIVE MECHANISM, CONVEYING APPARATUS, AND FLOW BATTERY ENERGY STORAGE SYSTEM, which is incorporated herein by reference in its entirety.

### TECHNICAL FIELD

The present disclosure relates to, but is not limited to, insulating protection technology, and in particular to an insulating protective mechanism, a conveying apparatus, and a flow battery energy storage system.

### BACKGROUND

With the rapid development of new clean energy in recent years, energy storage technology has developed rapidly in the industry. All-vanadium flow batteries are widely used in the energy storage industry due to their good stability and safety, becoming a mainstream technical solution in the energy storage field. A currently used electrolyte-dedicated conveying apparatus for a flow battery energy storage system is a magnetic pump, in which internal wiring of a motor thereof adopts a floating ground design where a 380-V three-phase line is connected to a motor input terminal, while a PE line is not connected. When a phase line comes into contact with a shell or there is induced electricity in the apparatus, a user may have a risk of electric shock from accidentally touching the metal shell of the motor (pump). A currently used method for preventing contact electric shock from the electric motor (pump) is to install an insulating protective cover outside the motor (pump). During actual operation of the flow battery energy storage system, if the insulating protective cover is not installed in place or is not restored in time after being removed, the metal shell of the motor (pump) will run live without shielding, and the user will be at risk of electric shock when passing by an exposed conductive part of the live apparatus.

### SUMMARY

A main purpose of the present disclosure is to provide an insulating protective mechanism, a conveying apparatus, and a flow battery energy storage system, which are intended to solve the technical problem that a user has a risk of electric shock when passing by an exposed conductive part of a live apparatus if an insulating protective cover is not installed in place or is not restored in time after being removed.

To achieve the above purpose, an embodiment of the present disclosure discloses an insulating protective mechanism, including:
a frame;
an insulating protective cover, arranged on the frame and capable of enclosing an installation space with the frame, the installation space having a space for installing a conveying mechanism;
a transmission assembly, transmissively connected between the frame and the insulating protective cover;
a sensing assembly, configured to monitor whether the installation space is closed; and
a control unit, configured to control the transmission assembly to drive the insulating protective cover to open or close the installation space.

In some embodiments of the insulating protective mechanism, the insulating protective cover includes a fixed portion and a movable portion, the fixed portion is fixed to the frame, the movable portion is movably connected to the fixed portion, and the transmission assembly is capable of driving the movable portion to move relative to the frame to open or close the installation space.

In some embodiments of the insulating protective mechanism, the transmission assembly includes a transmission unit, a gear, and a rack, the gear is arranged on an output end of the transmission unit, the transmission unit is arranged on one of the frame and the movable portion, the rack is arranged on the other of the frame and the movable portion and meshes with the gear, and the control unit controls the transmission unit to drive the movable portion to move relative to the frame by means of cooperation of the gear and the rack.

In some embodiments of the insulating protective mechanism, the sensing assembly is installed in the installation space, and the sensing assembly includes a photosensitive sensor.

In some embodiments of the insulating protective mechanism, a plurality of photosensitive sensors are provided.

In some embodiments of the insulating protective mechanism, the plurality of photosensitive sensors are arranged at intervals along a moving path of the movable portion, and are configured to monitor an opening size of the installation space.

To achieve the above purpose, an embodiment of the present disclosure further provides a conveying apparatus, including:
the insulating protective mechanism as described above; and
a conveying mechanism, installed in the installation space and arranged on the frame, the conveying mechanism being configured to convey an electrolyte to a battery stack.

In some embodiments of the conveying apparatus, the control unit is further configured to control the conveying mechanism to be constantly in a closed state after the sensing assembly monitors that the installation space is open, and to release the control of the conveying mechanism in the closed state after the sensing assembly monitors that the installation space is closed.

In some embodiments of the conveying apparatus, the conveying apparatus further includes an alarm unit configured to issue an alarm after the sensing assembly monitors that the installation space is open.

To achieve the above purpose, an embodiment of the present disclosure further provides a flow battery energy storage system, including:
a battery stack;
a liquid storage unit configured to store an electrolyte; and
the conveying apparatus as described above, the conveying mechanism conveying the electrolyte to the battery stack, so that the electrolyte circulates between the liquid storage unit, the conveying mechanism, and the battery stack.

Implementing the embodiments of the present disclosure will have the following beneficial effects:
The insulating protective mechanism in the foregoing solutions is applied to and equips the conveying apparatus and the flow battery energy storage system. In addition to protecting the conveying apparatus and the conveying mechanism in the flow battery energy storage system, the insulating protective mechanism can further monitor whether the insulating protective cover is closed, to prevent the conveying apparatus and the flow battery energy storage system from being turned on when the insulating protective cover is not closed, reducing a risk of electric shock. Specifically, the insulating protective mechanism includes a frame, an insulating protective cover, a transmission assembly, a sensing assembly, and a control unit. The insulating protective cover is arranged on the frame, and can enclose with the frame an installation space for installing a conveying mechanism. The control unit controls the transmission assembly to facilitate driving the insulating protective cover to open or close the installation space, so as to facilitate maintenance and replacement of the conveying mechanism in the installation space, and reset the insulating protective cover after the maintenance and replacement of the conveying mechanism. The sensing assembly can monitor whether the installation space is closed, to prevent the conveying apparatus and the flow battery energy storage system from being turned on when the insulating protective cover is not closed, reducing the risk of electric shock.

Other features and advantages of the present disclosure will be set forth in the following description, and in part will become apparent from the description, or may be understood by means of the implementation of the present disclosure. Other advantages of the present disclosure will be achieved and attained by means of the solutions described in the description and the accompanying drawings.

### BRIEF DESCRIPTION OF THE DRAWINGS

The accompanying drawings are used to provide an understanding of the technical solutions of the present disclosure and constitute a part of the description. Together with the embodiments of the present disclosure, the accompanying drawings are used to explain the technical solutions of the present disclosure and do not constitute a limitation to the technical solutions of the present disclosure.

FIG. 1 is a schematic diagram of an embodiment of a flow battery energy storage system of the present disclosure.

### DESCRIPTION OF REFERENCE NUMERALS

10. Battery stack; 20. Liquid storage unit; 30. Conveying mechanism; 40. Frame; 50. Insulating protective cover; 51. Fixed portion; 52. Movable portion; 60. Transmission assembly; 70. Control unit; 100. Installation space.

The purpose fulfilment, functional features, and advantages of the present disclosure will be further explained in conjunction with embodiments with reference to the accompanying drawings.

### DETAILED DESCRIPTION

In order to make the purpose, technical solutions, and advantages of the present disclosure more clear, embodiments of the present disclosure will be described below in detail with reference to the accompanying drawings. It should be noted that, the embodiments and features in the embodiments in the present disclosure can be combined with each other arbitrarily without conflicts.

With the rapid development of new clean energy in recent years, energy storage technology has developed rapidly in the industry. All-vanadium flow batteries are widely used in the energy storage industry due to their good stability and safety, becoming a mainstream technical solution in the energy storage field. A currently used electrolyte-dedicated conveying apparatus for a flow battery energy storage system is a magnetic pump, in which internal wiring of a motor thereof adopts a floating ground design where a 380-V three-phase line is connected to a motor input terminal, while a PE line is not connected. When a phase line comes into contact with a shell or there is induced electricity in the apparatus, a user may have a risk of electric shock from accidentally touching the metal shell of the motor (pump). A currently used method for preventing contact electric shock from the electric motor (pump) is to install an insulating protective cover outside the motor (pump). During actual operation of the flow battery energy storage system, if the insulating protective cover is not installed in place or is not restored in time after being removed, the metal shell of the motor (pump) will run live without shielding, and the user will be at risk of electric shock when passing by an exposed conductive part of the live apparatus.

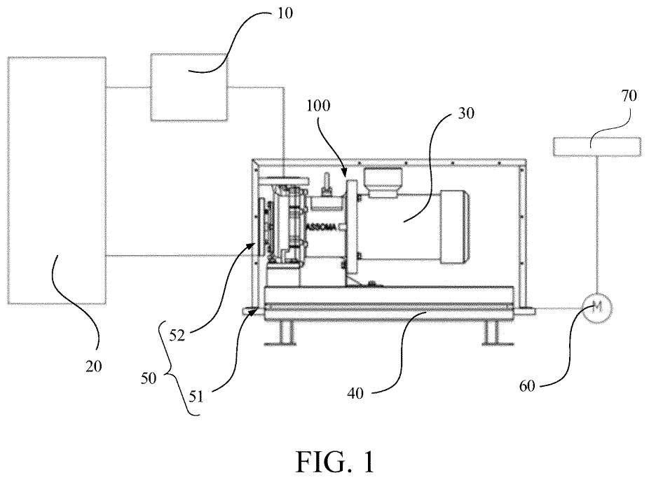

In order to solve the above technical problem, the embodiments of the present disclosure provide an insulating protective mechanism, a conveying apparatus, and a flow battery energy storage system. As shown in FIG. 1, a flow battery energy storage system includes a battery stack 10, a liquid storage unit 20, and a conveying apparatus. The liquid storage unit 20 is configured to store an electrolyte. The conveying apparatus includes an insulating protective mechanism and a conveying mechanism 30. The insulating protective mechanism includes a frame 40, an insulating protective cover 50, a transmission assembly 60, a sensing assembly (not shown), and a control unit 70. The insulating protective cover 50 is arranged on the frame 40. The insulating protective cover 50 can enclose an installation space 100 with the frame 40, and the installation space 100 has a space for installing the conveying mechanism 30. The transmission assembly 60 is transmissively connected between the frame 40 and the insulating protective cover 50. The sensing assembly is configured to monitor whether the installation space 100 is closed. The control unit 70 is configured to control the transmission assembly 60 to drive the insulating protective cover 50 to open or close the installation space 100. In an embodiment of the present disclosure, the conveying mechanism 30 is a magnetic pump. The control unit 70 is, but not limited to, a PLC controller. The conveying mechanism 30 is installed in the installation space 100 and arranged on the frame 40. The conveying mechanism 30 is configured to convey an electrolyte to the battery stack 10, so that the electrolyte circulates between the liquid storage unit 20, the conveying mechanism 30, and the battery stack 10.

In an embodiment of the present disclosure, the flow battery energy storage system is an all-vanadium flow battery energy storage system, which is a redox battery with vanadium as an active substance in a circulating flowing liquid state. Electric energy of the all-vanadium flow battery energy storage system is stored in the form of chemical energy in a sulfuric acid electrolyte containing vanadium ions of different valence states. The electrolyte is pressed into the battery stack 10 by means of the conveying mechanism 30. Under the action of mechanical power, the electrolyte is circulated in a closed loop of the liquid storage unit 20 and the battery stack 10. A proton exchange membrane is used as a diaphragm of the battery pack. The electrolyte solution flows in parallel over an electrode surface and an electrochemical reaction occurs. The current is collected and conducted through double electrode plates, thereby converting the chemical energy stored in the electrolyte into electric energy. It can be understood that in other embodiments, the flow battery energy storage system may also be, but not limited to, a lithium ion flow energy storage system, a zinc cerium flow energy storage system, an iron chromium flow energy storage system, or a zinc iron flow energy storage system.

In addition, in some embodiments, the conveying mechanism 30 may also be other apparatuses with risks of live operation, such as a driving mechanism or a water pump.

In summary, implementing the embodiments of the present disclosure will have the following beneficial effects: The insulating protective mechanism in the foregoing solution is applied to and equips the conveying apparatus and the flow battery energy storage system. In addition to protecting the conveying apparatus and the conveying mechanism 30 in the flow battery energy storage system, the insulating protective mechanism can further monitor whether the insulating protective cover 50 is closed, to prevent the conveying apparatus and the flow battery energy storage system from being turned on when the insulating protective cover 50 is not closed, reducing a risk of electric shock. Specifically, the insulating protective mechanism includes the frame 40, the insulating protective cover 50, the transmission assembly 60, the sensing assembly, and the control unit 70. The insulating protective cover 50 is arranged on the frame 40, and can enclose with the frame 40 the installation space 100 for installing the conveying mechanism 30. The control unit 70 controls the transmission assembly 60 to facilitate driving the insulating protective cover 50 to open or close the installation space 100, so as to facilitate maintenance and replacement of the conveying mechanism 30 in the installation space 100, and reset the insulating protective cover 50 after the maintenance and replacement of the conveying mechanism 30. The sensing assembly can monitor whether the installation space 100 is closed, to prevent the conveying apparatus and the flow battery energy storage system from being turned on when the insulating protective cover 50 is not closed, reducing the risk of electric shock.

In one embodiment, as shown in FIG. 1, the insulating protective cover 50 includes a fixed portion 51 and a movable portion 52. The fixed portion 51 is fixed to the frame 40, and the movable portion 52 can be movably connected to the fixed portion 51, so that part of the insulating protective cover 50 can be fixedly connected to the frame 40, increasing connection stability between the insulating protective cover 50 and the frame 40, thereby ensuring the stability of the installation space 100 enclosed by the insulating protective cover 50 and the frame 40, avoiding accidental collision with the conveying mechanism 30 located in the installation space 100, and ensuring that the conveying mechanism 30 has a more stable operating environment.

The transmission assembly 60 can drive the movable portion 52 to move relative to the frame 40 to open or close the installation space 100. By driving part of the structure of the insulating protective cover 50, energy consumption generated by driving the installation space 100 to open or close can be reduced. Furthermore, the transmission resistance of the transmission assembly 60 during transmission can be reduced, the loss caused by the transmission of the transmission mechanism can be reduced, and the life of the transmission assembly 60 can be improved. It can be understood that in other embodiments, the transmission assembly 60 may also be a lifting assembly, which is configured to drive the insulating protective cover 50 to move as a whole to achieve the opening or closing of the installation space 100.

In one embodiment, the transmission assembly 60 includes a transmission unit, a gear, and a rack. The gear is arranged on an output end of the transmission unit, the transmission unit is arranged on one of the frame 40 and the movable portion 52, and the rack is arranged on the other of the frame 40 and the movable portion 52 and meshes with the gear. In this way, by means of the meshing of the gear and the rack, the transmission accuracy between the frame 40 and the movable portion 52 can be improved, ensuring that the installation space 100 can be opened or closed smoothly. In an embodiment of the present disclosure, the transmission unit is arranged on the movable portion 52, and the rack is arranged on the frame 40. It can be understood that in other embodiments, the transmission unit may also be arranged on the frame 40, and the rack may be arranged on the movable portion 52.

The control unit 70 controls the transmission unit to drive the movable portion 52 to move relative to the frame 40 by means of the cooperation of the gear and the rack.

In one embodiment, the sensing assembly is installed in the installation space 100, and the sensing assembly includes a photosensitive sensor. When the installation space 100 is closed, there is no light or the light is dim in the installation space 100, and the photosensitive sensor cannot be triggered, and therefore it is determined that the installation space 100 is in a closed state. When the installation space 100 is open, light enters the installation space 100 and directly or indirectly irradiates on the photosensitive sensor to trigger the photosensitive sensor to send a signal, on which basis it is determined that the installation space 100 is in an open state. Compared with a laser sensor which may be blocked by the ambient and cause inaccurate monitoring, the photosensitive sensor is more compatible with the use status of the insulating protective cover 50, because the photosensitive sensor can be installed in the installation space 100 without being disturbed by the ambient, and has higher monitoring accuracy.

In one embodiment, a plurality of photosensitive sensors are provided to further improve the accuracy of monitoring whether the installation space 100 is closed. The plurality of photosensitive sensors are arranged at intervals along a moving path of the movable portion 52 to monitor an opening size of the installation space 100. The opening size of the installation space 100 can be determined based on the number of photosensitive sensors triggered. A signal sent by the photosensitive sensor after being triggered can be received by the control unit 70, and the control unit 70 can drive the movable portion 52 to move relative to the frame 40 according to the number of triggered photosensitive sensors to meet requirements on the opening size of the installation space 100. At this time, the light sensitivity of the photosensitive sensor can be adjusted appropriately to prevent the movable portion 52 from not moving in place, i.e., triggering the photosensitive sensor at that position to send a signal.

In one embodiment, the control unit 70 is further configured to control the conveying mechanism 30 to be constantly in a closed state after the sensing assembly monitors that the installation space 100 is open, so as to avoid live maintenance, and to avoid the operation of the flow battery energy storage system when the insulating protective cover 50 is not installed in place or is not restored in time after being removed. The control unit 70 is further configured to release the control of the conveying mechanism 30 in the closed state after the sensing assembly monitors that the installation space 100 is closed, so as to facilitate a user to control the operation of the flow battery energy storage system.

In one embodiment, the conveying apparatus further has an alarm unit (not shown), which is configured to issue an alarm after the sensing assembly monitors that the installation space 100 is open, so as to serve as a warning, indicating that the installation space 100 is in an open state, so as to avoid live maintenance, and to avoid operating the flow battery energy storage system when the insulating protective cover 50 is not installed in place or is not restored in time after being removed. The alarm unit may issue an alarm in at least one form of sound and light.

When the flow battery energy storage system is operating, the installation space 100 is constantly in a closed state. Once the flow battery energy storage system is shut down for maintenance, the installation space 100 is opened, the photosensitive sensor is exposed to ambient light, and sends a signal to the control unit 70. The control unit 70 triggers the alarm unit to alarm according to the signal. If the flow battery energy storage system is turned off (the conveying mechanism 30 is turned off), the control unit 70 will not intervene to control the flow battery energy storage system. If the flow battery energy storage system is not turned off (the conveying mechanism 30 is not turned off), the control unit 70 controls the conveying mechanism 30 to be constantly in a closed state.

Upon completion of the maintenance, when the installation space 100 is not closed, the photosensitive sensor continues to send a signal to the control unit 70. At this time, the control unit 70 controls the conveying mechanism 30 to be constantly in a closed state, and the alarm unit continues to alarm. When a worker needs to close the installation space 100, the worker controls the transmission unit via the control unit 70, to drive the movable portion 52 to move relative to the frame 40 through the cooperation of the gear and the rack, so as to close the installation space 100. After the installation space 100 is closed, the control unit 70 no longer intervenes in the opening and closing of the flow battery energy storage system (conveying mechanism 30). The control unit 70 can be connected to the conveying mechanism 30, the transmission assembly 60, the sensing assembly, and the alarm unit by wireless or wired signal connection.

In the description of the present disclosure, it should be noted that the orientational or positional relationships indicated by terms such as “upper”, “lower”, “one side”, “the other side”, “one end”, “the other end”, “edge”, “opposite”, “four corners”, “periphery”, and “square-shaped structure” are based on the orientational or positional relationships shown in the accompanying drawings and are only for the convenience of describing the present disclosure and simplifying the description, rather than indicating or implying that the structures referred to have specific orientations or are constructed and operated in specific orientations, and therefore cannot be understood as limiting the present disclosure.

In the description of the embodiments of the present disclosure, unless otherwise clearly specified and limited, the terms “connection”, “direct connection”, “indirect connection”, “fixed connection”, “installation”, and “assembly” should be understood in a broad sense. For example, the connection may be a fixed connection, a detachable connection, or an integral connection. The terms “installation”, “connection”, and “fixed connection” may be a direct connection, or an indirect connection through an intermediate medium, or a communication between the interiors of two components. For those skilled in the art, the specific meanings of the aforementioned terms in the present disclosure could be understood according to specific circumstances.

Although the implementations disclosed in the present disclosure are as above, the described contents are only implementations adopted to facilitate the understanding of the present disclosure and are not intended to limit the present disclosure. It should be noted that the above embodiments or implementations are merely illustrative rather than restrictive. Accordingly, the present disclosure is not limited to the contents specifically shown and described herein. Various modifications, substitutions, or omissions may be made in the forms and details of the implementation without departing from the scope of the present disclosure.

1. An insulating protective mechanism, characterized by comprising:
a frame;
an insulating protective cover, arranged on the frame and capable of enclosing an installation space with the frame, the installation space having a space for installing a conveying mechanism;
a transmission assembly, transmissively connected between the frame and the insulating protective cover;
a sensing assembly, configured to monitor whether the installation space is closed; and
a control unit, configured to control the transmission assembly to drive the insulating protective cover to open or close the installation space.

2. The insulating protective mechanism according to claim 1, wherein the insulating protective cover comprises a fixed portion and a movable portion, the fixed portion is fixed to the frame, the movable portion is movably connected to the fixed portion, and the transmission assembly is capable of driving the movable portion to move relative to the frame to open or close the installation space.

3. The insulating protective mechanism according to claim 2, wherein the transmission assembly comprises a transmission unit, a gear, and a rack, the gear is arranged on an output end of the transmission unit, the transmission unit is arranged on one of the frame and the movable portion, the rack is arranged on the other of the frame and the movable portion and meshes with the gear, and the control unit controls the transmission unit to drive the movable portion to move relative to the frame by means of cooperation of the gear and the rack.

4. The insulating protective mechanism according to claim 2, wherein the sensing assembly is installed in the installation space, and the sensing assembly comprises a photosensitive sensor.

5. The insulating protective mechanism according to claim 4, wherein a plurality of photosensitive sensors are provided.

6. The insulating protective mechanism according to claim 5, wherein the plurality of photosensitive sensors are arranged at intervals along a moving path of the movable portion, and are configured to monitor an opening size of the installation space.

7. A conveying apparatus, characterized by comprising:
the insulating protective mechanism according to claim 1; and
a conveying mechanism, installed in the installation space and arranged on the frame, the conveying mechanism being configured to convey an electrolyte to a battery stack.

8. The conveying apparatus according to claim 7, wherein the control unit is further configured to control the conveying mechanism to be constantly in a closed state after the sensing assembly monitors that the installation space is open, and to release the control of the conveying mechanism in the closed state after the sensing assembly monitors that the installation space is closed.

9. The conveying apparatus according to claim 8, wherein the conveying apparatus further comprises an alarm unit configured to issue an alarm after the sensing assembly monitors that the installation space is open.

10. A flow battery energy storage system, characterized by comprising:
a battery stack;
a liquid storage unit configured to store an electrolyte; and
the conveying apparatus according to claim 7, the conveying mechanism conveying the electrolyte to the battery stack, so that the electrolyte circulates between the liquid storage unit, the conveying mechanism, and the battery stack.
